(19) United States
(12) Patent Application Publication
(10) Pub. No.: US 2020/0174814 A1
(43) Pub. Date: Jun. 4, 2020

(54) SYSTEMS AND METHODS FOR UPGRADING HYPERVISOR LOCALLY

(71) Applicant: Nutanix, Inc., San Jose, CA (US)

(72) Inventors: Prerna Saxena, Bangalore (IN); Felipe Franciosi, Cambridge (GB)

(73) Assignee: Nutanix, Inc., San Jose, CA (US)

(21) Appl. No.: 16/207,028

(22) Filed: Nov. 30, 2018

(51) Int. Cl. G06F 9/455; G06F 9/48

(52) U.S. Cl. CPC G06F 9/45558; G06F 9/485; G06F 8/65; G06F 2009/45583; G06F 2009/4557

(57) ABSTRACT

Systems and methods for migrating an original instance of a virtual machine (VM) to a new instance of the VM within a same host include generating, by a hypervisor of the host, memory mapping corresponding to a memory state of the original instance of the VM, sharing the memory mapping with the new instance of the VM, and migrating to the new instance of the VM based on the memory mapping.

### BACKGROUND

The following description is provided to assist the understanding of the reader. None of the information provided or references cited is admitted to be prior art.

A hypervisor of a host (e.g., a node, a machine, or a computer) configures the host to run one or more instances of virtual machines (VMs) by virtualizing or otherwise transforming hardware of the host into resources for the VMs. Conventionally, when a hypervisor of a host becomes unavailable (e.g., due to hypervisor upgrade, break-fix, state cleanup, component change, maintenance, power-off, or the like), all VMs supported by the host are required to be evacuated from the host and migrated to another host (e.g., via a network) until the original host is back online. For example, when a hypervisor of an original host is being upgraded, all VMs supported by the original host are migrated to a destination host via a network. When full system emulation component of the hypervisor of the original host has been upgraded, the VMs are migrated back to the original host via the network.

Such migration of the VMs is a disruptive and time-consuming, as VMs running on the original host are live-migrated to the destination host via the network. The performance of the VMs is impaired given that resources allocated to the VMs are throttled during the migration due to lack of resources during the migration. For example, when the VMs are migrated to the destination host, memory of the VMs is also copied from the original host to the destination host, hindering the access to memory which is considerably latency-sensitive.

### SUMMARY

In accordance with at least some aspects of the present disclosure, a method for migrating an original instance of a VM to a new instance of the VM within a same host including generating, by a hypervisor of the host, memory mapping corresponding to a memory state of the original instance of the VM, sharing the memory mapping with the new instance of the VM, and migrating to the new instance of the VM based on the memory mapping.

In accordance with at least some aspects of the present disclosure, a host configured to migrate an original instance of a VM to a new instance of the VM within the same host, the host includes a processing unit having a processor and a memory, wherein the processing unit is configured to generate memory mapping corresponding to a memory state of the original instance of the VM, share the memory mapping with the new instance of the VM, and migrate to the new instance of the VM based on the memory mapping.

In accordance with at least some aspects of the present disclosure, a non-transitory computer readable medium includes computer-executable instructions embodied thereon that, when executed by a processor of a host, cause the host to migrating an original instance of a virtual machine (VM) to a new instance of the VM within the host by generating memory mapping corresponding to a memory state of the original instance of the VM, sharing the memory mapping with the new instance of the VM, and migrating to the new instance of the VM based on the memory mapping.

The foregoing summary is illustrative only and is not intended to be in any way limiting. In addition to the illustrative aspects, implementations, and features described above, further aspects, implementations, and features will become apparent by reference to the following drawings and the detailed description.

### BRIEF DESCRIPTION OF THE DRAWINGS

FIG. 1 is a block diagram of a host, in accordance with some implementations of the present disclosure.

FIG. 2 is a diagram illustrating memory mapping, in accordance with some implementations of the present disclosure.

FIG. 3 is a flowchart outlining operations of a method for migrating an original instance of a VM to a new instance of the VM within the host, in accordance with some implementations of the present disclosure.

The foregoing and other features of the present disclosure will become apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Implementations described herein relate to providing same-host migration for VMs supported by a host when a hypervisor of the host is unavailable. As used herein, “same-host migration” refers to migrating one or more VMs supported by a host to new instances of the VMs supported by the same host. The same-host migration as described herein allows new instances of VMs to be created without evacuating the VMs from the host. Migrating VMs on the same host is much faster as compared to evacuating the VMs from the original host to a destination host because memory or storage of the VMs does not need to be copied and communicated over a network to the destination host.

In a conventional same-host migration, memory of the VMs is copied to the new instances of the VM on a same host. Thus, the host requires sufficient memory space to store another copy of the memory of the VMs. This is an inefficient use of the host's storage resources. Arrangements described herein enable same-host migration without copying the memory of the VMs, improving memory-efficiency of the host in same-host migration. The same-host migration described herein can be used for any instances in which a hypervisor of a host is restarted or becomes temporarily unavailable.

In some arrangements, in performing same-host migration of a VM hosted by a host, memory state of the VM is transferred from an original instance of the VM (e.g., an original hypervisor version) to a new instance of the VM (e.g., a new hypervisor version) within the same host by sharing memory mappings with the new instance of the VM. By sharing the memory mapping instead of copying the memory, the host does not need to store two copies of the memory state of the same VM, thus improving data storage efficiency of the host. As data (e.g., files) is created for the original instance of the VM, the data is stored in the memory of the host, and data mapping is backed by a filesystem of the host. The memory mapping maps the data with physical locations (e.g., physical pages) in the memory where the data is stored. Thus, any process having access to the memory mapping can also access the data mapped by the memory mapping. As long as the new instance of the VM has access to the memory mapping of the original instance of the VM, the memory state of the original instance of the VM does not need to be copied for the new instance of the VM.

The arrangements described herein further include copying a device state or an emulator state of the original instance of the VM to the new instance of the VM.

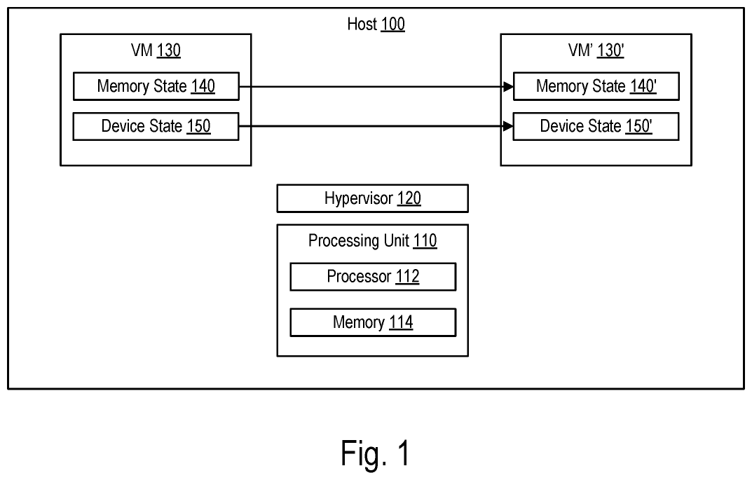

Referring now to FIG. 1, an example block diagram of a host 100 is shown, in accordance with some implementations of the present disclosure. In some examples, the host 100 is part of a datacenter that supports VMs (such as but not limited to, VMs 130 and 130′) for one or more clients (not shown). Services commensurate with the VMs provided by the datacenter can be provided to the clients under respective service-level agreements (SLAs), which may specify performance requirements of the VM. In that regard, the datacenter may include multiple nodes or machines for provisioning the VMs, each node or machine can be a host such as the host 100. In some implementations, the host 100 can be a hardware device such as but is not limited to a server. For example, the host 100 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other examples, the host 120 can be another type of device such as but not limited to, a desktop computer, a laptop computer, a workstation computer, a mobile communication device, a smart phone, a tablet device, a server, a mainframe, an eBook reader, a Personal Digital Assistant (PDA), and the like.

The host 100 includes a processing unit 110 configured to execute instructions to perform functions of the processing unit 110 described herein. The processing unit 110 can be implemented in hardware, firmware, software, or any combination thereof. For example, the processing unit 110 includes a processor 112 and memory 114. The instructions are stored in the memory 114 and are carried out by the processor 112. The processor 112 can be a special purpose computer, logic circuits, or hardware circuits. The term “execution” is used to describe completing a process of running an application or the carrying out of an operation called for by the instructions. The instructions can be written using one or more programming language, scripting language, assembly language, etc. The processing unit 110, thus, executes instructions, meaning that the processing unit 110 performs the operations called for by the instructions. The hypervisor 120, the VM 130, and the VM′ 130′ can be implemented with the processing unit 100.

The host 100 can support one or more VMs such as but not limited to, VM 130 and VM′ 130′. The VM 130 is used to refer to an original instance of a VM supported by the host 100 before same-host migration. The VM′ 130′ is used to refer to new instance of the VM (the VM 130), after the VM 130 is migrated to the VM′ 130′.

Each of the VM 130 and the VM′ 130′ is a software-based implementation of a computing machine provided by the host 100. The VM 130 and the VM′ 130′ emulate the functionality of a physical computer. Specifically, the hardware resources, such as the processing unit 110, additional memory, storage, network, etc., of the host 100 are virtualized or transformed by the hypervisor 120 into the underlying support for the VM 130 and the VM′ 130′, each of which can run a dedicated operating system (OS) and applications/processes on the underlying physical resources similar to an actual computer. By encapsulating an entire machine, including the CPU, the memory, the OS, the storage devices, and the network devices, the VM 130 and the VM′ 130′ are compatible with most standard OSs (e.g. Windows, Linux, etc.), applications, and device drivers.

The VM 130 and the VM′ 130′ can be managed by the hypervisor 120. The hypervisor 120 is a virtual machine monitor or emulator that allows a single physical server computer (e.g., the host 100) to run multiple instances of VMs. Two or more VMs (e.g., the VM 130 and another VM not shown, or the VM′ 130′ and another VM not shown) can share the resources (e.g., the processing unit 110) of the host 100. By running multiple VMs on each of the host 100, multiple workloads and multiple OSs may be run on a single piece of hardware computer to increase resource utilization and manage workflow.

The host 100 may further include a suitable network device (not shown) configured to enable communications over a network such as but not limited to, a cellular network, Wi-Fi, Wi-Max, ZigBee, Bluetooth, a proprietary network, Ethernet, one or more twisted pair wires, coaxial cables, fiber optic cables, local area networks, Universal Serial Bus (“USB”), Thunderbolt, any other type of wired or wireless network, or a combination thereof. The network is structured to permit the exchange of data, instructions, messages, or other information among different hosts of a datacenter or with another suitable computer. The network device is also a resource that can be shared by the VM 130 and the VM′ 130′.

As described, the VM 130 can be migrated within the same host 100 to become the VM′ 130′. Migration refers to moving an entire state of the VM from the VM 130 (e.g., the original instance) to the VM′ 130′ (e.g., the new instance). In other words, the memory and storage of the VM 130 can be transferred to the VM′ 130′.

A memory state 140 of the VM 130 refers to current memory content of the VM 130, including but not limited to, transaction data, OS state (e.g., bits of OS), application/process state (e.g., bits of applications/processes) that are stored in the memory 114 or another suitable storage or memory unit of the host 100 is operatively coupled to the host 100. The memory state 140 can be transferred to the VM′ 130′ to become a memory state 140′. As described, the memory state 140 can be transferred via the memory mapping.

A device state 150 (or emulator state) of the VM 130 refers to defining and identification information of the VM 130 including but not limited to, all data that maps the VM 130 to hardware elements (emulated devices), such as BIOS, devices, CPU (e.g., the processing unit 110), MAC addresses for the Ethernet cards, chip set states, registers, video display state, interrupt states, signal/wire states, and the like. The device state 150 can be extracted by the hypervisor 120 (e.g., from the memory 114 or another suitable storage or memory unit of the host 100) and copied to different memory locations of the memory 114 or another suitable storage or memory unit of the host 100, to become the device state 150′.

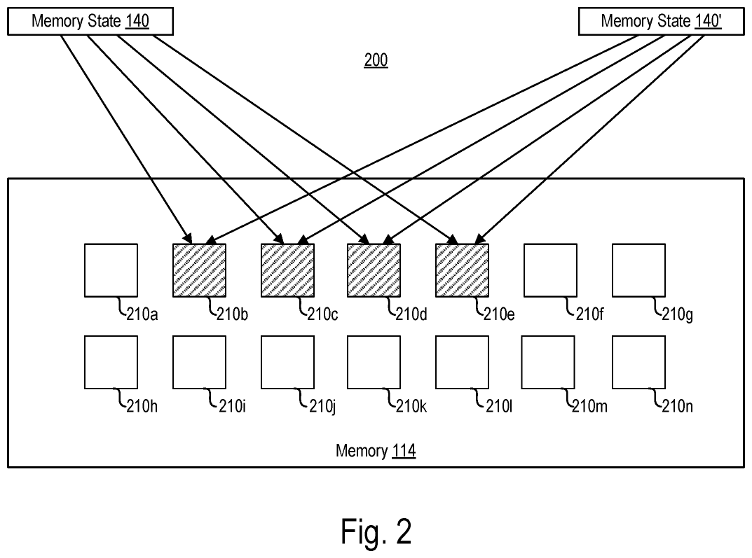

FIG. 2 is a diagram illustrating memory mapping 200, in accordance with some implementations of the present disclosure. Referring to FIGS. 1-2, the memory mapping 200 references physical locations (e.g., pages 210a-210n on a processor that supports paging) of the memory 114. Preferably, the range of physical memory cells are addressed contiguously. For example, the memory 114 may include the pages 210a-210n as representations of storage capacity of the memory 114, and one of ordinary skill in the art can appreciate that the memory 114 can hold more or less pages. Data corresponding to the memory state 140 of the VM 130 is stored, as an example, in the pages 210b-210e. Instead of copying the data stored in the pages 210b-210e to other pages 210a and 210f-210n as performed in conventional same-host migration, the arrangements disclosed herein relate to sharing the memory mapping to the pages 210b-210e with the VM′ 130′ such that the memory state 140′ of the VM′ 130′ can be notified of the physical locations (e.g., the pages 210b-210e) of the data corresponding to the memory state 140 by receiving the memory mapping in the manner described.

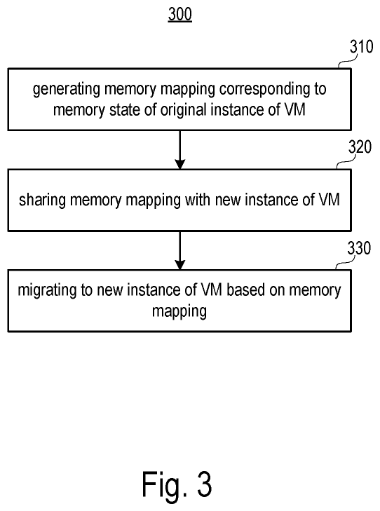

FIG. 3 is a flowchart outlining operations of a method 300 for migrating an original instance of a VM (e.g., the VM 130) to a new instance of the VM (e.g., the VM′ 130′) within a host (e.g., the host 110), in accordance with some implementations of the present disclosure. Additional, fewer, or different operations many be performed depending on the implementation of the method. Referring to FIGS. 1-3, the method can be executed by the processing unit 110 and/or the hypervisor 120. The method 300 can be executed when or responsive to the hypervisor 120 is restarted or becomes temporarily unavailable, for example, due to hypervisor upgrade, break-fix, state cleanup, component change, maintenance, power-off, or the like.

At 310, memory mapping corresponding to the memory state 140 of the original instance of the VM (the VM 130) is generated. In one example in which the hypervisor 120 is a Unix-based hypervisor such as but not limited to, a Kernel-based Virtual Machine (KVM) hypervisor, the hypervisor 120 can create at least one file descriptor that represents the memory mapping (e.g., the memory mapping 200) corresponding to the memory state 140 of the VM 130. For example, the at least one file descriptor can indicate that the data corresponding to the memory state 140 is stored in the pages 210b-210e of the memory 114.

At 320, the memory mapping is shared with the new instance of the VM (the VM′ 130′). For example, sharing the memory mapping includes sharing, by the processing unit 110 and/or the hypervisor 120, the at least one file descriptor via inter-process communication channels such as sockets. An example socket is a Unix socket or an Inter-Process Communication (IPC) socket, which is a data communication endpoint configured to exchange data between processes executing on the OS of the host 100.

At 330, the original instance of the VM (the VM 130) is migrated to the new instance of the VM (the VM′ 130′) based on the memory mapping. The processes and/or applications executed by the processing unit 110 and/or the hypervisor 120 for the VM′ 130′ can access the memory mapping (e.g., the at least one file descriptor) via the inter-process communication channels. The VM′ 130′ can access the memory mapping using a memory-backed filesystem, for example, using a filesystem namespace of the memory-backed filesystem. The memory-backed filesystem (e.g., HugeTLBfs) can be implemented by the processing unit 110 and/or the hypervisor 120 for storing the memory state 140. The at least one file descriptor is accessible to the VM′ 130′ via the filesystem namespace of the memory-backed filesystem. The at least one file descriptor can be directly read by the VM′ 130′ created by the hypervisor 120. Thus, the VM′ 130′ can access the memory state 140 of the VM 130 using the memory mapping.

The hypervisor 120 can copy the device state 150 of the VM 130 to the VM′ 130′, to enable the device state 150′. As described, the hypervisor 120 can extract the device state 150 from the memory 114 or another suitable storage or memory unit of the host 100 and can copy the device state to different memory locations of the memory 114 or another suitable storage or memory unit of the host 100, for access by the VM′ 130′.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

It is also to be understood that in some implementations, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

1. A method comprising:
generating, by a hypervisor of a host, memory mapping corresponding to a memory state of an original instance of a virtual machine(VM);
sharing the memory mapping with a new instance of the VM within a same host; and
migrating to the new instance of the VM based on the memory mapping.

2. The method of claim 1, wherein generating the memory mapping corresponding to the memory state of the original instance of the VM comprises creating at least one file descriptor that represents the memory mapping corresponding to the memory state of the original instance of the VM.

3. The method of claim 2, wherein the at least one file descriptor is shared with the new instance of the VM via sockets.

4. The method of claim 1, further comprising accessing, by the new instance of the VM, the memory mapping using a memory-backed filesystem.

5. The method of claim 4, wherein the memory mapping is represented by at least one file descriptor, and the memory mapping is accesses by the new instance of the VM using a filesystem namespace of the memory-backed filesystem.

6. The method of claim 1, further comprising accessing, by the new instance of the VM, the memory state of the original instance of the VM using the memory mapping.

7. The method of claim 1, further comprising copying, by the hypervisor, a device state of the original instance of the VM to the new instance of the VM.

8. The method of claim 7, wherein the device state corresponds to defining information and identification information of the original instance of the VM.

9. The method of claim 1, wherein the memory state corresponds to current memory content of the original instance of the VM.

10. A host comprising
a processing unit having programmed instructions to:
generate memory mapping corresponding to a memory state of an original instance of a virtual machine(VM);
share the memory mapping with a new instance of the VM within the same host; and
migrate to the new instance of the VM based on the memory mapping.

11. The host of claim 10, wherein the processing unit has further programmed instructions to generate the memory mapping corresponding to the memory state of the original instance of the VM by creating at least one file descriptor that represents the memory mapping corresponding to the memory state of the original instance of the VM.

12. The host of claim 11, wherein the at least one file descriptor is shared with the new instance of the VM via sockets.

13. (canceled)

14. The host of claim 10, wherein the processing unit has further programmed instructions to access the memory mapping for the new instance of the VM using a memory-backed filesystem.

15. The host of claim 14, wherein the memory mapping is represented by at least one file descriptor, and the memory mapping is accesses using a filesystem namespace of the memory-backed filesystem.

16. The host of claim 10, wherein the processing unit has further programmed instructions to access the memory state of the original instance of the VM using the memory mapping.

17. The host of claim 10, wherein the processing unit has further programmed instructions to copy a device state of the original instance of the VM to the new instance of the VM.

18. The host of claim 17, wherein the device state corresponds to defining information and identification information of the original instance of the VM.

19. The host of claim 10, wherein the memory state corresponds to current memory content of the original instance of the VM.

20. A non-transitory computer readable medium includes computer-executable instructions embodied thereon that, when executed by a processor of a host, cause operations comprising:
generating memory mapping corresponding to a memory state of an original instance of a virtual machine(VM);
sharing the memory mapping with a new instance of the VM within a same host; and
migrating to the new instance of the VM based on the memory mapping.

21. The medium of claim 20, wherein generating the memory mapping corresponding to the memory state of the original instance of the VM comprises creating at least one file descriptor that represents the memory mapping corresponding to the memory state of the original instance of the VM.

22. The medium of claim 21, wherein the at least one file descriptor is shared with the new instance of the VM via sockets.

23. The medium of claim 20, further comprising accessing, by the new instance of the VM, the memory mapping using a memory-backed filesystem.

24. The medium of claim 23, wherein the memory mapping is represented by at least one file descriptor, and the memory mapping is accesses by the new instance of the VM using a filesystem namespace of the memory-backed filesystem.

25. The medium of claim 20, further comprising accessing, by the new instance of the VM, the memory state of the original instance of the VM using the memory mapping.

26. The medium of claim 20, further comprising copying, by the hypervisor, a device state of the original instance of the VM to the new instance of the VM.

27. The medium of claim 26, wherein the device state corresponds to defining information and identification information of the original instance of the VM.

28. The medium of claim 20, wherein the memory state corresponds to current memory content of the original instance of the VM.
